(19) United States
(12) Patent Application Publication
(10) Pub. No.: US 2025/0112647 A1
(43) Pub. Date: Apr. 3, 2025

(54) ELECTRONIC DEVICE AND METHOD FOR PERFORMING COMMUNICATION THROUGH MULTIPLE CHANNELS

(71) Applicant: SAMSUNG ELECTRONICS CO., LTD., Suwon-si (KR)

(72) Inventors: Janghyun NAM, Suwon-si (KR); Taeyun LEE, Suwon-si (KR)

(21) Appl. No.: 18/981,316

(22) Filed: Dec. 13, 2024

Related U.S. Application Data
(63) Continuation of application No. PCT/KR2023/008015, filed on Jun. 12, 2023.

(30) Foreign Application Priority Data
Jun. 13, 2022 (KR) 10-2022-0071791
Jul. 5, 2022 (KR) 10-2022-0082814

(51) Int. Cl. H04B 1/00; H04B 1/40

(52) U.S. Cl. CPC H04B 1/0057; H04B 1/40

(57) ABSTRACT

An electronic device, according to one embodiment, comprises: a first front-end module; a second front-end module; a third front-end module; a first diplexer; a second diplexer; and at least one processor, wherein the at least one processor is configured to: acquire, through the first diplexer, one of a first signal on a 5 GHz band and a second signal on a 6 GHz band on the basis of at least one signal provided to the first diplexer from at least one of the first front-end module and the second front-end module; and acquire, through the second diplexer, one of a third signal on a 2.4 GHz band and a fourth signal on a band that is 5 GHz or higher on the basis of at least one signal provided to the second diplexer from at least one of the first diplexer or the third front-end module.

### CROSS REFERENCE TO RELATED APPLICATIONS

This application is a continuation application of International Application No. PCT/KR2023/008015, filed on Jun. 12, 2023, in the Korean Intellectual Property Office and claiming priority to Korean Patent Application No. 10-2022-0071791, filed on Jun. 13, 2022, in the Korean Intellectual Property Office and further claiming priority to Korean Patent Application No. 10-2022-0082814, filed on Jul. 5, 2022, in the Korean Intellectual Property Office, all of which are incorporated by reference herein in their entireties.

### TECHNICAL FIELD

The following descriptions relate to an electronic device and a method for performing communication through a plurality of channels.

### BACKGROUND

Discussions on IEEE 802.11be specification are ongoing. Accordingly, integrated circuits or frontend circuits according to the IEEE802.11be specification are also being developed. An electronic device according to the IEEE 802.11be specification may support a multi-link operation. An electronic device supporting the multi-link operation may communicate with at least one external electronic device using a plurality of channels (or links).

### DISCLOSURE

An electronic device may communicate with at least one external electronic device using one or more channels among a plurality of channels (or links) configured in a 2.4 GHz band, a 5 GHz band, and a 6 GHz band. The electronic device may communicate with a first external electronic device using a first core and communicate with a second external electronic device using a second core. In this case, a structure of new frontend circuit and a method for efficiently setting a channel may be required.

The solutions to technical problems to be achieved in this document are not limited to those described above, and other technical problems not mentioned herein will be clearly understood by those having ordinary knowledge in the art to which the present disclosure belongs, from the following description.

According to an embodiment, an electronic device may comprise a first frontend module, a second frontend module, a third frontend module, a first diplexer connected with the first frontend module and the second frontend module respectively, comprising a first filter configured to pass a signal in a 5 GHz band and a second filter configured to pass a signal in a 6 GHz band, a second diplexer connected with the third frontend module and the first diplexer respectively, comprising a third filter configured to pass a signal in a 2.4 GHz band and a fourth filter configured to pass a signal in a band over 5 GHz, and at least one processor, wherein the at least one processor may be configured to obtain one signal among a first signal in the 5 GHz band and a second signal in the 6 GHz band, based on at least one signal provided to the first diplexer from at least one of the first frontend module or the second frontend module through the first diplexer, and obtain one signal among a third signal in the 2.4 GHz band and a fourth signal in the band over 5 GHz, based on at least one signal provided to the second diplexer from at least one of the first diplexer or the third frontend module through the second diplexer.

According to an embodiment, an electronic device may comprise at least one antenna, a frontend circuit electrically connected to the at least one antenna, and at least one processor operably coupled to the frontend circuit, wherein the at least one processor may be configured to identify, while communicating with a first external electronic device using a first channel, an event for performing communication with a second external electronic device, using the first channel and another channel distinct from the first channel, identify a type of the first external electronic device as one of a first type and a second type, based on the event, identify a second channel based on channel information identified based on the type of the first external electronic device, identify the identified second channel as the other channel, while communicating with the first external electronic device using the first channel, communicate with the second external electronic device using the second channel.

### ADVANTAGEOUS EFFECTS

According to an embodiment, a structure of a frontend circuit for performing a real simultaneous dual band (RSDB) operation or a multi-link operation may be proposed. According to the structure of the proposed frontend circuit, an even frequency band may be allocated to a plurality of cores. Therefore, the entire frequency band available for the electronic device to communicate with an external electronic device can be efficiently used.

The effects that can be obtained from the present disclosure are not limited to those described above, and any other effects not mentioned herein will be clearly understood by those having ordinary knowledge in the art to which the present disclosure belongs, from the following description.

### DESCRIPTION OF THE DRAWINGS

FIG. 1 is a block diagram of an electronic device in a network environment according to an embodiment.

FIG. 2 illustrates a channel set in a 5 GHz band to a 6 GHz band, according to an embodiment.

FIG. 3A illustrates an operation of an electronic device supporting an RSDB operation, according to an embodiment.

FIG. 3B illustrates an operation of an electronic device supporting a multi-link operation, according to an embodiment.

FIG. 4 illustrates a simplified block diagram of an electronic device according to an embodiment.

FIG. 5A illustrates components included in an electronic device and an electrical path between components, according to an embodiment.

FIG. 5B illustrates a frequency band passed by filters of a diplexer according to an embodiment.

FIG. 6A illustrates components included in an electronic device and an electrical path between components, according to an embodiment.

FIG. 6B illustrates a frequency band passed by filters of a diplexer according to an embodiment.

FIG. 7 illustrates components included in an electronic device and an electrical path between components, according to an embodiment.

FIG. 8 is a flowchart illustrating an operation of an electronic device according to an embodiment.

FIG. 9 is a flowchart illustrating an operation of an electronic device according to an embodiment.

FIG. 10 is a flowchart illustrating an operation of an electronic device according to an embodiment.

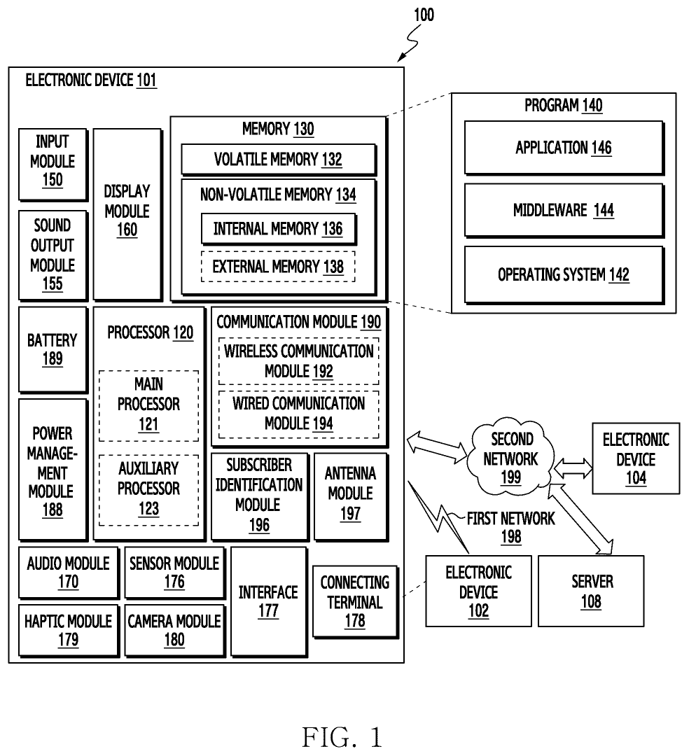

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

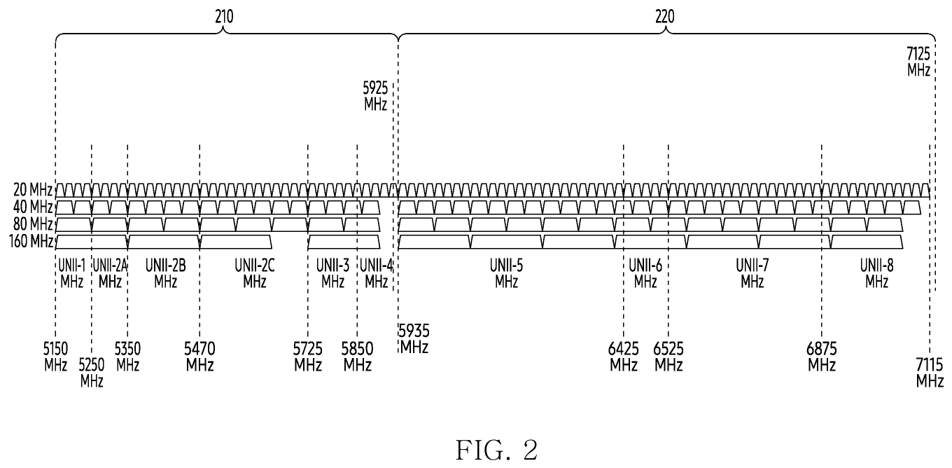

FIG. 2 illustrates a channel set in a 5 GHz band to a 6 GHz band, according to an embodiment.

Referring to FIG. 2, a plurality of channels may be set in a 5 GHz band 210 to a 6 GHz band 220. For example, a plurality of channels set in the 5 GHz band 210 may be set within 5.150 GHz to 5.935 GHz. The 5 GHz band 210 may include Unlicensed National Information Infrastructure (UNII)-1, UNII-2, UNII-3, and UNII-4. For example, a plurality of channels set in the 6 GHz band 220 may be set within 5.935 GHz to 7.125 GHz. The 6 GHz band 220 may include UNII-5, UNII-6, UNII-7, and UNII-8. For example, a channel index may be set for each of a plurality of channels set within the 5 GHz band 210 to the 6 GHz band 220.

For example, a bandwidth of each of the plurality of channels set within the 5 GHz band 210 to the 6 GHz band 220 may be set to at least one of 20 MHz, 40 MHz, 80 MHz, 160 MHz, and 320 MHz. For example, the number of 20 MHz channels within the 5 GHz band 210 may be set to 38 (or 36). As an example, the number of 40 MHz channels within the 5 GHz band 210 may be set to 18. As an example, the number of 80 MHz channels within the 5 GHz band 210 may be set to 9. As an example, the number of 160 MHz channels within the 5 GHz band 210 may be set to 4. As an example, the number of 20 MHz channels within the 6 GHz band 220 may be set to 59. As an example, the number of 40 MHz channels within the 6 GHz band 220 may be set to 29. As an example, the number of 80 MHz channels within the 6 GHz band 220 may be set to 14. As an example, the number of 160 MHz channels within the 6 GHz band 220 may be set to 7.

The plurality of channels set within the 5 GHz band 210 to the 6 GHz band 220 illustrated in FIG. 2 are exemplary, and a frequency range or a channel index may be changed according to the country in which the plurality of channels are used. Although a channel configured with 20, 40, 80, and 160 MHz are illustrated in FIG. 2, it is not limited thereto. In addition to the illustrated channel, 240 MHz channels or 320 MHz channels may be added.

According to an embodiment, the plurality of channels set within the 5 GHz band 210 to the 6 GHz band 220 may be used for a wireless local area network (WLAN). In addition, a plurality of channels set within the 2.4 GHz band may be used for the WLAN together with the plurality of channels set within the 5 GHz band 210 to the 6 GHz band 220.

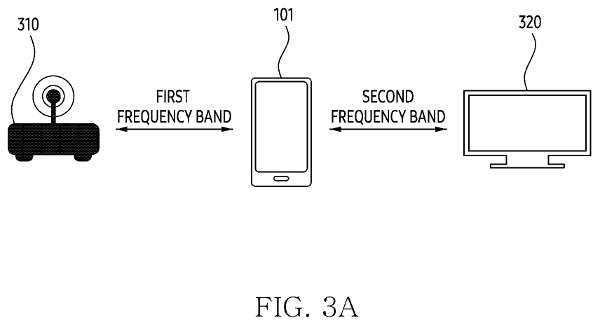

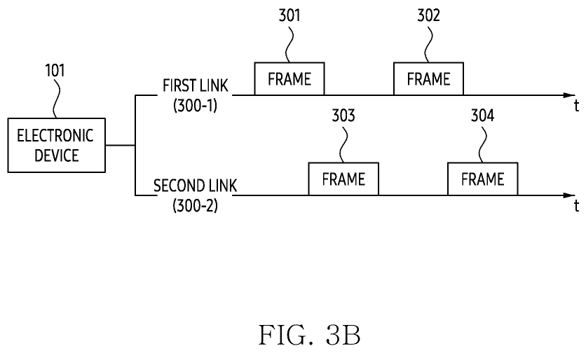

FIG. 3A illustrates an operation of an electronic device supporting an RSDB operation, according to an embodiment.

Referring to FIG. 3A, an electronic device 101 may support a real simultaneous dual band (RSDB) operation. The RSDB may refer to a technology for simultaneously connecting different frequency bands in a wireless LAN module.

For example, the electronic device 101 may establish a connection with a first external electronic device 310, by using a channel of a first frequency band (e.g., 2.4 GHz band). The electronic device 101 may establish a connection with a second external electronic device 320, by using a channel of a second frequency band (e.g., 5 GHz band). For example, the electronic device 101 may perform communication through a channel of the first frequency band using a first core (or first processing circuitry) within the electronic device 101. The electronic device 101 may perform communication through a channel of the second frequency band using a second core (or second processing circuitry) within the electronic device 101. The electronic device 101 may simultaneously communicate with the first external electronic device 310 and the second external electronic device 320 by using different cores. As an example, the electronic device 101 may communicate with the first external electronic device 310 performing a function of an access point (AP). The electronic device 101 may communicate with the second external electronic device 320 through a peer-to-peer (P2P) connection.

According to an embodiment, the electronic device 101 may communicate with the first external electronic device 310 and the second external electronic device 320 by using different cores. For example, based on 2×2 MIMO, the electronic device 101 may allocate 2.4 GHz 2×2 to a channel for performing communication with the first external electronic device 310 and 5 GHz 2×2 to a channel for performing communication with the second external electronic device 320. The electronic device 101 may allocate 6 GHz 2×2 to a channel for performing communication with the second external electronic device 320. Therefore, the electronic device 101 may simultaneously establish a connection with the first external electronic device 310 and the second external electronic device 320 in different bands.

According to an embodiment, in order to operate simultaneously in the first frequency band (e.g., 2.4 GHz band) and the second frequency band (e.g., 5 GHz band) in the electronic device 101, a physical layer (PHY layer) and a medium access control layer (MAC layer) may be separated from each other according to the frequency band. Accordingly, throughput performance of the electronic device 101 may depend on a core of the 2.4 GHz band. For example, the maximum throughput of a modulation and coding scheme (MCS) 11 in the 5 GHz band or 6 GHz band may be 2400 Mbps. The maximum throughput of MCS 11 in the 2.4 GHz band may be 230 Mbps. Therefore, when the electronic device 101 is operated according to an AP connection (e.g., connection with the first external electronic device 310) and a P2P connection (e.g., connection with the second external electronic device 320), the maximum throughput may be 230 Mbps. In other words, when the electronic device 101 is operated according to the AP connection and the P2P connection, the performance of the electronic device 101 may be limited.

FIG. 3B illustrates an operation of an electronic device supporting a multi-link operation, according to an embodiment.

Referring to FIG. 3B, an electronic device 101 according to IEEE 802.11be specification may support a multi-link. The electronic device 101 may perform communication through the multi-link. For example, the electronic device 101 may perform communication through a first link 300-1 within a first frequency band (e.g., the 2.4 GHz band) and a second link 300-2 within a second frequency band (e.g., the 5 GHz band). For example, the electronic device 101 may perform communication through the first link 300-1 and the second link 300-2 within the second frequency band (e.g., the 5 GHz band).

According to an embodiment, the electronic device 101 may communicate with a first external electronic device through the first link 300-1, and communicate with a second external electronic device through the second link 300-2. For example, the first link 300-1 may be included in the first frequency band. The second link 300-2 may be included in the second frequency band.

According to an embodiment, communication with the first external electronic device through the first link 300-1 and communication with the second external electronic device through the second link 300-2 may be performed individually. For example, the electronic device 101 may transmit a frame 301 (e.g., a physical layer protocol data unit (PPDU)) to the first external electronic device through the first link 300-1. The electronic device 101 may receive a frame 302 from the first external electronic device through the first link 300-1. The electronic device 101 may receive a frame 303 from the second external electronic device through the second link 300-2. The electronic device 101 may transmit a frame 304 to the second external electronic device through the second link 300-2.

According to an embodiment, the electronic device 101 may communicate with a first external electronic device (e.g., AP) through both a first link and a second link.

According to an embodiment, four cores and four antennas according to each core are required to perform a multi-link operation in the 5 GHz band and the 6 GHz band, but the electronic device 101 may include two antennas. Hereinafter, in the electronic device 101 including two antennas, an example of a structure of the electronic device 101 and an operation of the electronic device 101 for supporting the RSDB operation and/or the multi-link operation may be described.

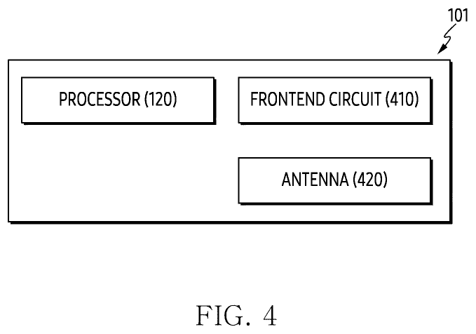

FIG. 4 illustrates a simplified block diagram of an electronic device according to an embodiment.

Referring to FIG. 4, an electronic device 101 may include a processor 120, a frontend circuit 410, and/or an antenna 420. According to an embodiment, the electronic device 101 may include at least one of the processor 120, the frontend circuit 410, and the antenna 420. For example, at least a portion of the processor 120, the frontend circuit 410, and the antenna 420 may be omitted according to an embodiment.

According to an embodiment, the processor 120 may be operably coupled with or connected with the frontend circuit 410. For example, the processor 120 may control the frontend circuit 410. The frontend circuit 410 may be controlled by the processor 120. For example, the processor 120 may be configured with at least one processor. The processor 120 may include at least one processor. For example, the processor 120 may include a communication processor (CP).

According to an embodiment, the processor 120 may include a plurality of cores for processing data based on radio access technology (RAT). For example, the processor 120 may perform communication by using some or all of a plurality of cores included in the processor 120.

According to an embodiment, the processor 120 may include a hardware component for processing data based on one or more instructions. The hardware component for processing data may include, for example, an Arithmetic and Logic Unit (ALU), a Field Programmable Gate Array (FPGA), and/or a Central Processing Unit (CPU).

According to an embodiment, the electronic device 101 may include the frontend circuit 410. For example, when transmitting a signal, the processor 120 may convert a baseband signal into a radio frequency (RF) signal using the frontend circuit 410. When receiving a signal, the processor 120 may use the frontend circuit 410 to preprocess the RF signal obtained from the antenna 420 and convert the preprocessed RF signal into a baseband signal.

According to an embodiment, the frontend circuit 410 may include at least one component for transmitting and/or receiving a signal. For example, the frontend circuit 410 may include at least one frontend module, at least one switch, and/or at least one diplexer. An example of a detailed configuration of the frontend circuit 410 will be described later.

According to an embodiment, the electronic device 101 may include the antenna 420. For example, the antenna 420 may be configured with at least one antenna. For example, the antenna 420 may be configured with two antennas. For example, the antenna 420 may be used to transmit a signal in the 2.4 GHz band, a signal in the 5 GHz band, and/or a signal in the 6 GHz band. The antenna 420 may be used to receive a signal in the 2.4 GHz band, a signal in the 5 GHz band, and/or a signal in the 6 GHz band. As an example, the antenna 420 may be used to transmit a wireless signal based on an electrical signal received from the frontend circuit 410. In response to receiving a wireless signal, the antenna 420 may be used to output an electrical signal corresponding to the received wireless signal to the frontend circuit 410.

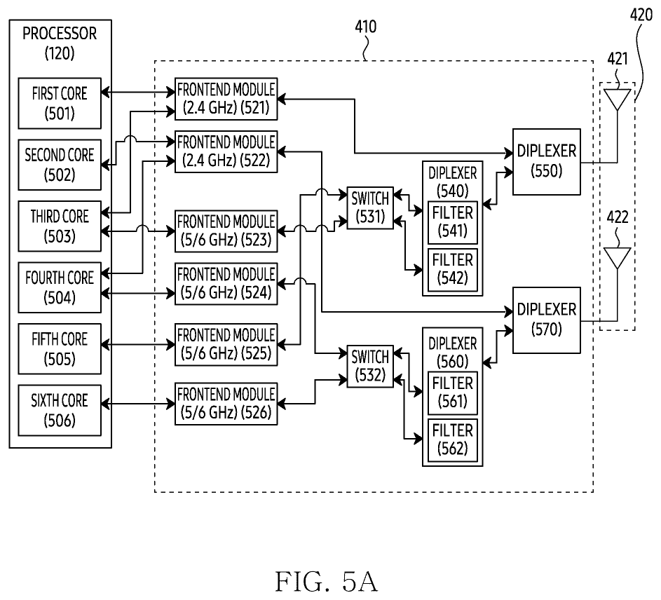

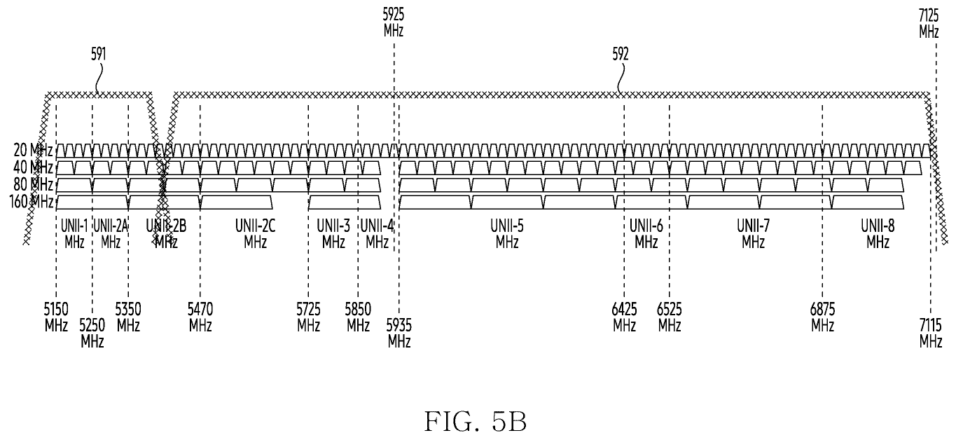

FIG. 5A illustrates components included in an electronic device and an electrical path between components, according to an embodiment.

FIG. 5B illustrates a frequency band passed by filters of a diplexer according to an embodiment.

Referring to FIG. 5A, the processor 120 may include a first core 501 to a sixth core 506. For example, a first core 501 and a second core 502 may be used to process a Bluetooth signal in a 2.4 GHz band. For example, a third core 503 and a fourth core 504 may be used to construct (or process) a wireless LAN signal with a bandwidth less than or equal to 160 MHz within the 2.4 GHz, 5 GHz, and 6 GHz bands. For example, a fifth core 505 and a sixth 506 may be used to construct (or process) a wireless LAN signal with a bandwidth less than or equal to 320 MHz within the 2.4 GHz, 5 GHz, and 6 GHz bands.

For example, a frontend module 521 included in a frontend circuit 410 may be connected to the first core 501 and the third core 503. The frontend module 521 may be used to convert a baseband signal received from the first core 501 and/or the third core 503 into a wireless signal in the 2.4 GHz band.

For example, a frontend module 522 included in the frontend circuit 410 may be connected to the second core 502 and the fourth core 504. The frontend module 522 may be used to convert a baseband signal received from the second core 502 and/or the fourth core 504 into a wireless signal in the 2.4 GHz band.

For example, a frontend module 523 included in the frontend circuit 410 may be connected to the third core 503. The frontend module 523 may be used to convert a baseband signal received from the third core 503 into a wireless signal in the 5 GHz band or the 6 GHz band.

For example, a frontend module 524 included in the frontend circuit 410 may be connected to the fourth core 504. The frontend module 524 may be used to convert a baseband signal received from the fourth core 504 into a wireless signal in the 5 GHz band or the 6 GHz band.

For example, a frontend module 525 included in the frontend circuit 410 may be connected to the fifth core 505. The frontend module 525 may be used to convert a baseband signal received from the fifth core 505 into a wireless signal in the 5 GHz band or the 6 GHz band.

For example, a frontend module 526 included in the frontend circuit 410 may be connected to the sixth core 506. The frontend module 526 may be used to convert a baseband signal received from the sixth core 506 into a wireless signal in the 5 GHz band or the 6 GHz band.

According to an embodiment, a switch 531 may be connected to the frontend module 523 and the frontend module 525. The processor 120 may transmit at least one wireless signal received from the frontend module 523 and the frontend module 525 to a diplexer 540, by controlling the switch 531. The processor 120 may transmit at least one wireless signal received from the diplexer 540 to at least one of the frontend module 523 and the frontend module 525, by controlling the switch 531.

According to an embodiment, a switch 532 may be connected to the frontend module 524 and the frontend module 526. The processor 120 may transmit at least one wireless signal received from the frontend module 524 and the frontend module 526 to a diplexer 560, by controlling the switch 532. The processor 120 may transmit at least one wireless signal received from the diplexer 560 to at least one of the frontend module 524 and the frontend module 526, by controlling the switch 532.

According to an embodiment, the diplexer 540 may be connected to the switch 531 and a diplexer 550. For example, the diplexer 540 may include a filter 541 and a filter 542. The filter 541 may be configured to pass a signal in a band from 5.47 GHz (or 5470 MHz) to 7.125 GHz (or 7125 MHz). The filter 542 may be configured to pass a signal in a band from 5.15 GHz (or 5150 MHz) to 5.35 GHz (or 5350 MHz).

For example, a first signal transmitted from the frontend module 523 and/or the frontend module 525 to the diplexer 540 through the switch 531 may pass through at least one of the filter 541 and/or the filter 542. The first signal passing through at least one of the filter 541 and/or the filter 542 may be transmitted from the diplexer 540 to the diplexer 550.

For example, a second signal transmitted from the diplexer 550 may pass through at least one of the filter 541 and/or the filter 542. The second signal passing through at least one of the filter 541 and/or the filter 542 may be transmitted from the diplexer 540 to at least one of the frontend module 523 and the frontend module 525 through the switch 531.

According to an embodiment, the diplexer 560 may be connected to the switch 532 and a diplexer 570. For example, the diplexer 560 may include a filter 561 and a filter 562. The filter 561 may be configured to pass a signal in a band from 5.47 GHz (or 5470 MHz) to 7.125 GHz (or 7125 MHz). The filter 561 may correspond to the filter 541. The filter 562 may be configured to pass a signal in a band from 5.15 GHz (or 5150 MHz) to 5.35 GHz (or 5350 MHz). The filter 562 may correspond to the filter 542.

For example, a third signal transmitted from the frontend module 524 and/or the frontend module 526 to the diplexer 560 through the switch 532 may pass through at least one of the filter 541 and/or the filter 542. The third signal passing through at least one of the filter 541 and/or the filter 542 may be transmitted from the diplexer 560 to the diplexer 570.

For example, a fourth signal transmitted from the diplexer 570 may pass through at least one of the filter 561 and/or the filter 562. The fourth signal passing through at least one of the filter 561 and/or the filter 562 may be transmitted from the diplexer 560 to at least one of the frontend module 524 and the frontend module 526 through the switch 532.

According to an embodiment, the diplexer 550 may be connected to the diplexer 540, the frontend module 521, and an antenna 421. For example, a fifth signal in the 2.4 GHz band may be transmitted from the frontend module 521 to the diplexer 550. A first signal in a band of 5 GHz or more (or a first signal in the 5 GHz band and/or the 6 GHz band) may be transmitted from the diplexer 540 to the diplexer 550. At least one of the first signal and the fifth signal may be transmitted to the antenna 421 through the diplexer 550. At least one of the first signal and the fifth signal transmitted to the antenna 421 may be transmitted to the outside through the antenna 421.

According to an embodiment, the diplexer 570 may be connected to the diplexer 560, the frontend module 522, and an antenna 422. For example, a sixth signal in the 2.4 GHz band may be transmitted from the frontend module 522 to the diplexer 570. A third signal in a band of 5 GHz or more (or a third signal in the 5 GHz band and/or the 6 GHz band) may be transmitted from the diplexer 560 to the diplexer 570. At least one of the third signal and the sixth signal may be transmitted to the antenna 422 through the diplexer 570. At least one of the third signal and the sixth signal transmitted to the antenna 422 may be transmitted to the outside through the antenna 422.

Referring to FIG. 5B, a pass band of filters included in the diplexer 540 and the diplexer 560 may be set to a first band 591 and a second band 592, respectively.

According to an embodiment, the electronic device 101 may share one antenna (e.g., antenna 421 or antenna 422) in the 5 GHz band to the 6 GHz band. Accordingly, the diplexer 540 and the diplexer 560 may divide a signal in the 5 GHz band to 6 GHz band into a signal in the first band 591 and a signal in the second band 592.

For example, the filter 541 included in the diplexer 540 may be configured to pass a signal in a band from 5.47 GHz to 7.125 GHz. In other words, a pass band of the filter 541 may be set to the second band 592 from 5.47 GHz to 7.125 GHz.

For example, the filter 542 included in the diplexer 540 may be configured to pass a signal in a band from 5.15 GHz to 5.35 GHz. In other words, a pass band of the filter 542 may be set to the first band 591 from 5.15 GHz to 5.35 GHz.

For example, the filter 561 included in the diplexer 560 may be configured to pass a signal in a band from 5.47 GHz to 7.125 GHz. In other words, a pass band of the filter 561 may be set to the second band 592 from 5.47 GHz to 7.125 GHz.

For example, the filter 562 included in the diplexer 560 may be configured to pass a signal in a band from 5.15 GHz to 5.35 GHz. In other words, a pass band of the filter 562 may be set to the first band 591 from 5.15 GHz to 5.35 GHz.

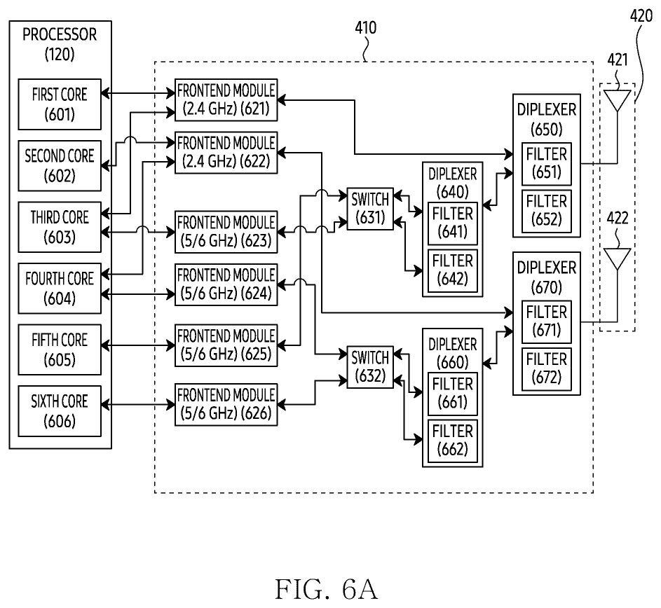

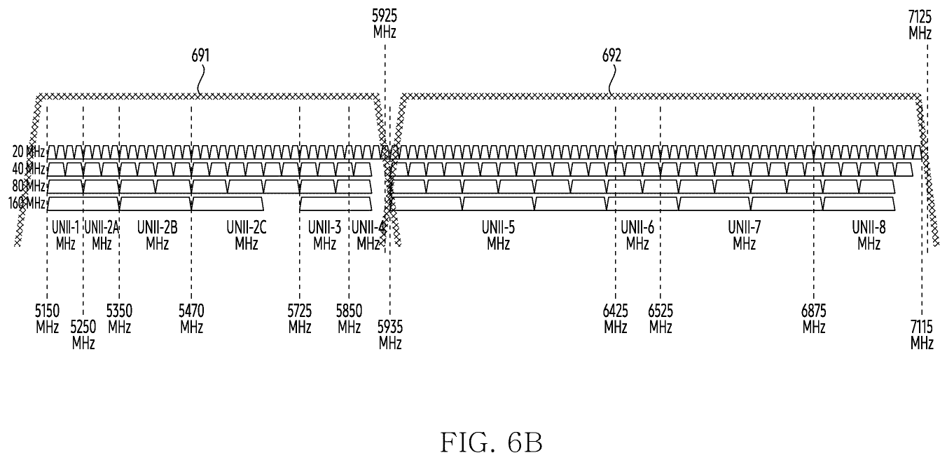

Referring to FIGS. 5A and 5B, the electronic device 101 may include the diplexer 540 and the switch 531 (or the diplexer 560 and the switch 532) to avoid frequency interference between signals in the 5 GHz band to 6 GHz band. Since the 5 GHz band to 6 GHz band are asymmetrically divided into the first band 591 and the second band 592, the diplexer 540 and the diplexer 560 may not use frequency efficiently when transmitting signals. For example, when the third core 503 and the fourth core 504 are used and a signal in the first band 591 from 5.15 GHz to 5.35 GHz is transmitted, the processor 120 may perform the RSDB operation or the multi-link operation using a small bandwidth of 200 MHz. In this case, RF performance may deteriorate. Thus, in order to prevent the deterioration of the RF performance, an electrical path between components of the electronic device 101 may be configured as illustrated in FIG. 6A.

FIG. 6A illustrates components included in an electronic device and an electrical path between components, according to an embodiment.

FIG. 6B illustrates a frequency band passed by filters of a diplexer according to an embodiment.

Referring to FIG. 6A, a processor 120 may include a first core 601 to a sixth core 606. For example, a first core 601 and a second core 602 may be used to process a Bluetooth signal in a 2.4 GHz band. For example, a third core 603 and a fourth core 604 may be used to construct a wireless LAN signal with a bandwidth less than or equal to 160 MHz within the 2.4 GHz, 5 GHz, and 6 GHz bands. For example, a fifth core 605 and a sixth core 606 may be used to process a wireless LAN signal with a bandwidth less than or equal to 320 MHz within the 2.4 GHz, 5 GHz, and 6 GHz bands or the 5 GHz and 6 GHz bands. For example, the fifth core 605 and the sixth core 606 may be used to process a wireless LAN signal with a bandwidth less than or equal to 320 MHz within the 2.4 GHz, 5 GHz, and 6 GHz bands. For example, the fifth core 605 and the sixth core 606 may be used to process a wireless LAN signal with a bandwidth less than or equal to 320 MHz within the 5 GHz band and/or the 6 GHz band. The first core 601 to the sixth core 606 may correspond to the first core 501 to the sixth core 506 illustrated in FIG. 5A, respectively.

For example, a frontend module 621 included in a frontend circuit 410 may be connected to the first core 601 and the third core 603. The frontend module 621 may be used to convert a baseband signal received from the first core 601 and/or the third core 603 into a wireless signal in the 2.4 GHz band.

For example, a frontend module 622 included in the frontend circuit 410 may be connected to the second core 602 and the fourth core 604. The frontend module 622 may be used to convert a baseband signal received from the second core 602 and/or the fourth core 604 into a wireless signal in 2.4 GHz band.

For example, a frontend module 623 included in the frontend circuit 410 may be connected to the third core 603. The frontend module 623 may be used to convert a baseband signal received from the third core 603 into a wireless signal in the 5 GHz band or the 6 GHz band.

For example, a frontend module 624 included in the frontend circuit 410 may be connected to the fourth core 604. The frontend module 624 may be used to convert a baseband signal received from the fourth core 604 into a wireless signal in the 5 GHz band or the 6 GHz band.

For example, a frontend module 625 included in the frontend circuit 410 may be connected to the fifth core 605. The frontend module 625 may be used to convert a baseband signal received from the fifth core 605 into a wireless signal in the 5 GHz band or the 6 GHz band.

For example, a frontend module 626 included in the frontend circuit 410 may be connected to the sixth core 606. The frontend module 626 may be used to convert a baseband signal received from the sixth core 606 into a wireless signal in the 5 GHz band or the 6 GHz band.

According to an embodiment, a switch 631 may be connected to the frontend module 623 and the frontend module 625. The processor 120 may transmit at least one wireless signal received from the frontend module 623 and the frontend module 625 to a diplexer 640, by controlling the switch 631. The processor 120 may transmit at least one wireless signal received from the diplexer 640 to at least one of the frontend module 623 and the frontend module 625, by controlling the switch 631.

According to an embodiment, a switch 632 may be connected to the frontend module 624 and the frontend module 626. The processor 120 may transmit at least one wireless signal received from the frontend module 624 and the frontend module 626 to a diplexer 660, by controlling the switch 632. The processor 120 may transmit at least one wireless signal received from the diplexer 660 to at least one of the frontend module 624 and the frontend module 626, by controlling the switch 632.

According to an embodiment, the diplexer 640 may be connected to the switch 631 and a diplexer 650. For example, the diplexer 640 may include a filter 641 and a filter 642. The filter 641 may be configured to pass a signal in a 6 GHz band. The filter 642 may be configured to pass a signal in a 5 GHz band. For example, the 5 GHz band may be 5.125 GHz to 5.935 GHz. The 6 GHz band may be 5.935 GHz to 7.125 GHz.

For example, a first signal transmitted from the frontend module 623 and/or the frontend module 625 to the diplexer 640 through the switch 631 may pass through at least one of the filter 641 and/or filter 642. The first signal passing through at least one of the filter 641 and/or the filter 642 may be transmitted from the diplexer 640 to the diplexer 650.

For example, a second signal transmitted from the diplexer 650 may pass through at least one of the filter 641 and/or the filter 642. The second signal passing through at least one of the filter 641 and/or the filter 642 may be transmitted from the diplexer 640 to at least one of the frontend module 623 and the frontend module 625 through the switch 631.

According to an embodiment, the diplexer 660 may be connected to the switch 632 a diplexer 670. For example, the diplexer 660 may include a filter 661 and a filter 662. The filter 661 may be configured to pass a signal in the 6 GHz band. The filter 662 may be configured to pass a signal in the 5 GHz band. The filter 661 may correspond to the filter 641. The filter 662 may correspond to the filter 642.

For example, a third signal transmitted from the frontend module 624 and/or the frontend module 626 to the diplexer 660 through the switch 632 may pass through at least one of the filter 661 and/or the filter 662. The third signal passing through at least one of the filter 661 and/or the filter 662 may be transmitted from the diplexer 660 to the diplexer 670.

For example, a fourth signal transmitted from the diplexer 670 may pass through at least one of the filter 661 and/or the filter 662. The fourth signal passing through at least one of the filter 661 and/or the filter 662 may be transmitted from the diplexer 660 to at least one of the frontend module 624 and the frontend module 626 through the switch 632.

According to an embodiment, the diplexer 650 may be connected to the diplexer 640, the frontend module 621, and an antenna 421. For example, a fifth signal in the 2.4 GHz band may be transmitted from the frontend module 621 to the diplexer 650. A first signal in a band of 5 GHz or more (or a first signal in the 5 GHz band and/or the 6 GHz band) may be transmitted from the diplexer 640 to the diplexer 650. At least one of the first signal and the fifth signal may be transmitted to the antenna 421 through the diplexer 650. At least one of the first signal and the fifth signal transmitted to the antenna 421 may be transmitted to the outside through the antenna 421.

For example, the diplexer 650 may include a filter 651 and a filter 652. A pass band of the filter 651 may be set to a band of 5 GHz or more. A pass band of the filter 652 may be set to a 2.4 GHz band. As an example, the filter 651 may be configured to pass a signal in a band of 5 GHz or more. As an example, the filter 651 may be configured to pass a signal in the 5 GHz band to the 6 GHz band. As an example, the filter 652 may be configured to pass a signal in the 2.4 GHz band.

According to an embodiment, the diplexer 670 may be connected to the diplexer 660, the frontend module 624, and an antenna 422. For example, a sixth signal in the 2.4 GHz band may be transmitted from the frontend module 622 to the diplexer 670. A third signal in a band of 5 GHz or more (or a third signal in the 5 GHz band and/or the 6 GHz band) may be transmitted from the diplexer 660 to the diplexer 670. At least one of the third signal and the sixth signal may be transmitted to the antenna 422 through the diplexer 670. At least one of the third signal and the sixth signal transmitted to the antenna 422 may be transmitted to the outside through the antenna 422.

For example, the diplexer 670 may include a filter 671 and a filter 672. A pass band of the filter 671 may be set to a band of 5 GHz or more. A pass band of the filter 672 may be set to a 2.4 GHz band. The filter 671 may correspond to the filter 651. The filter 672 may correspond to the filter 672.

Referring to FIG. 6B, a pass band of filters included in the diplexer 640 and the diplexer 660 may be set to a first band 691 and a second band 692, respectively.

According to an embodiment, the electronic device 101 may share one antenna (e.g., antenna 421 or antenna 422) in the 5 GHz band to the 6 GHz band. Accordingly, the diplexer 640 and the diplexer 660 may divide a signal in the 5 GHz band to the 6 GHz band into the first band 691 and the second band 692.

For example, the filter 641 included in the diplexer 640 may be configured to pass a signal in the 6 GHz band. In other words, a pass band of the filter 641 may be set to the second band 692 from 5.935 GHz to 7.125 GHz.

For example, the filter 642 included in the diplexer 640 may be configured to pass a signal in the 5 GHz band. In other words, a pass band of the filter 642 may be set to the first band 691 from 5.125 GHz to 5.935 GHz.

For example, the filter 661 included in the diplexer 660 may be configured to pass a signal in the 6 GHz band. In other words, a pass band of the filter 661 may be set to the second band 692 from 5.935 GHz to 7.125 GHz.

For example, the filter 662 included in the diplexer 660 may be configured to pass a signal in the 5 GHz band. In other words, a pass band of the filter 662 may be set to the first band 691 of 5.125 GHz to 5.935 GHz.

Referring to FIGS. 6A and 6B, the processor 120 may individually simultaneously operate different cores to perform an RSDB operation and/or a multi-link operation. The processor 120 may divide a band (or frequency band) according to the operating core through a diplexer (e.g., the diplexer 640 or the diplexer 660).

According to an embodiment, a pass band of the filter 641 of the diplexer 640 and the filter 661 of the diplexer 660 may be set to the 6 GHz band, and a pass band of the filter 642 of the diplexer 640 and the filter 662 of the diplexer 660 may be symmetrically set to the 5 GHz band. According to an embodiment, the processor 120 may use the switch 631 and/or the switch 632 to set a core used to transmit a signal among the third core 603 to the sixth core 606 and control the set core. For example, the processor 120 may use the third core 603 and/or the fourth core 604 in the 5 GHz band, and the fifth core 605 and/or the sixth core 606 in the 6 GHz band. Accordingly, the processor 120 may efficiently use the 5 GHz band to the 6 GHz band.

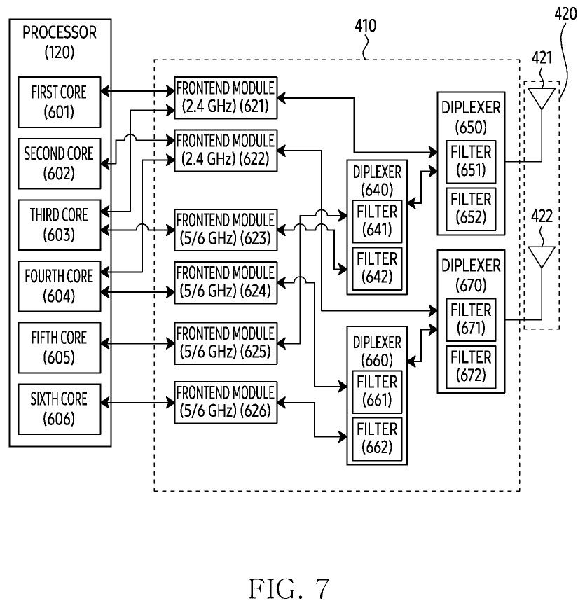

FIG. 7 illustrates components included in an electronic device and an electrical path between components, according to an embodiment.

Referring to FIG. 7, an electronic device 101 may include at least a portion of the components included in the electronic device 101 illustrated in FIG. 6A. According to an embodiment, the electronic device 101 may not include the switch 631 and the switch 632 among the components included in the electronic device 101 illustrated in FIG. 6A. In other words, the switch 631 for connecting the frontend module 623 and the frontend module 625 with the diplexer 640 may be omitted. The switch 632 for connecting the frontend module 624 and the frontend module 626 with the diplexer 660 may be omitted. Since a band for performing communication using the filter 641, the filter 642, the filter 661, and the filter 662 is symmetrically configured in the 5 GHz band and the 6 GHz band, the switch 631 and the switch 632 may be omitted. In case that the switch 631 and the switch 632 are omitted, the overall RF path loss may be improved and thus RF performance may be increased. Also, since the switch 631 and the switch 632 are omitted, there may be a cost reducing effect.

According to an embodiment, when an RSDB operation or a multi-link operation is performed, a plurality of channels may be used for signal exchange. For example, the processor 120 may perform the multi-link operation by using a plurality of links among a plurality of links (or channels) within the 5 GHz band to the 6 GHz band. For example, the processor 120 may perform the RSDB operation by using a first channel of a plurality of channels within the 5 GHz band and a second channel of a plurality of channels within the 6 GHz band. As an example, even when the first channel within the 5 GHz band is in a busy state, the processor 120 may perform the RSDB operation using one of remaining channels excluding the first channel within the 5 GHz band, and the second channel within the 6 GHz band. For example, even when the second channel within the 6 GHz band is in a busy state, the processor 120 may perform the RSDB operation using one of remaining channels excluding the second channel within the 6 GHz band, and the first channel within the 5 GHz band.

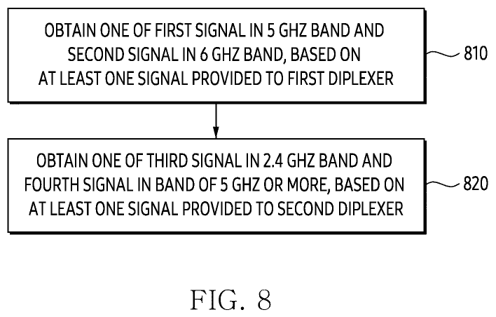

FIG. 8 is a flowchart illustrating an operation of an electronic device according to an embodiment.

Referring to FIG. 8, operations 810 and 820 of FIG. 8 may be performed by the electronic device 101 illustrated in FIG. 6A or 7.

In operation 810, the processor 120 of the electronic device 101 may obtain one of a first signal in the 5 GHz band and a second signal in the 6 GHz band, based on at least one signal provided to a first diplexer (e.g., the diplexer 640 of FIG. 6A or FIG. 7). For example, the processor 120 may obtain one of the first signal in the 5 GHz band and the second signal in the 6 GHz band, based on at least one signal provided to the first diplexer from at least one of a first frontend module (e.g., the frontend module 623 of FIG. 6A or FIG. 7) or a second frontend module (e.g., the frontend module 625 of FIG. 6A or FIG. 7).

For example, the processor 120 may obtain the first signal in the 5 GHz band by using a first filter (e.g., the filter 642 of FIG. 6A or FIG. 7) configured to pass a signal in the 5 GHz band, included in the first diplexer. The processor 120 may obtain the second signal in the 6 GHz band by using a second filter (e.g., the filter 641 of FIG. 6A or FIG. 7) configured to pass a signal in the 6 GHz band, included in the first diplexer.

For example, the processor 120 may provide at least one signal from at least one of the first frontend module and the second frontend module to the first diplexer through a switch (e.g., the switch 631 of FIG. 6A). For example, the processor 120 may change a state of the switch to change at least one signal provided from at least one of the first frontend module and the second frontend module. According to an embodiment, the switch may be a double pole double throw (DPDT) switch. The processor 120 may change a state (e.g., a first state or a second state) of the switch to change at least one signal provided from at least one of the first frontend module and the second frontend module. For example, the first state may be a state for connecting the first frontend module with the first diplexer. The second state may be a state for connecting the second frontend module with the first diplexer.

In operation 820, the processor 120 may obtain one of a third signal (e.g., the fifth signal of FIG. 6A) in a 2.4 GHz band and a fourth signal in a band of 5 GHz or more, based on at least one signal provided to a second diplexer. For example, the processor 120 may obtain one of the third signal in the 2.4 GHz band or the fourth signal in the band of 5 GHz or more through the second diplexer, based on at least one signal provided to the second diplexer from at least one of the first diplexer or a third frontend module (e.g., the frontend module 621 of FIG. 6A or FIG. 7).

According to an embodiment, at least one signal may be provided to the second diplexer from at least one of the first diplexer and the third frontend module. For example, the processor 120 may provide (or transmit) a signal in the 2.4 GHz band to the second diplexer using the third frontend module. The signal in the 2.4 GHz band may be provided to the second diplexer. For example, a signal in a band of 5 GHz or more may be provided from the first diplexer to the second diplexer. The signal in the band of 5 GHz or more transmitted from the first diplexer and the signal in the 2.4 GHz band transmitted from the third frontend module may be provided to the second diplexer.

For example, the processor 120 may obtain the third signal in the 2.4 GHz band using a third filter (e.g., the filter 652 of FIG. 6A or FIG. 7) configured to pass a signal in the 2.4 GHz band, included in the second diplexer. The processor 120 may obtain a fourth signal in a band of 5 GHz or more, by using a fourth filter (e.g., the filter 651 of FIG. 6A or FIG. 7) configured to pass a signal in the band of 5 GHz or more, included in the second diplexer.

According to an embodiment, the second diplexer may be connected to an antenna (e.g., the antenna 421). For example, the signal obtained through the second diplexer may be transmitted through the antenna. The processor 120 may transmit one of the third signal in the 2.4 GHz band and the fourth signal in the band of 5 GHz or more, obtained through the second diplexer, through the antenna. For example, a signal received through the antenna may be transmitted to the second diplexer.

According to an embodiment, at least one signal provided to the second diplexer may include a wireless LAN signal within the 2.4 GHz band and/or a Bluetooth signal within the 2.4 GHz band, which are transmitted from the third frontend module. For example, the processor 120 may generate (or process) the wireless LAN signal within the 2.4 GHz band or the Bluetooth signal within the 2.4 GHz band, by using the third frontend module. The processor 120 may transmit the wireless LAN signal within the 2.4 GHz band or the Bluetooth signal within the 2.4 GHz band to the second diplexer by using the third frontend module.

According to an embodiment, at least one signal provided to the second diplexer may include a wireless LAN signal in a band of 5 GHz or more transmitted from the first diplexer.

According to an embodiment, at least one signal provided to the first diplexer from at least one of the first frontend module or the second frontend module may include a wireless LAN signal within the 5 GHz band or the 6 GHz band. The processor 120 may generate (or process) a wireless LAN signal within the 5 GHz band or the 6 GHz band, by using the first frontend module or the second frontend module. For example, the processor 120 may generate (or process) a wireless LAN signal within the 5 GHz band using the first frontend module, and generate (or process) a wireless LAN signal within the 6 GHz band using the second frontend module.

According to an embodiment, the processor 120 may generate (or process) a wireless LAN signal with a bandwidth smaller than a first reference bandwidth, by using the first frontend module. The processor 120 may generate (or process) a wireless LAN signal with a bandwidth smaller than a second reference bandwidth, by using the second frontend module. For example, the first reference bandwidth may be set to be smaller than the second reference bandwidth. As an example, the first reference bandwidth may be set to 160 MHz. The second reference bandwidth may be set to 320 MHz.

For example, the processor 120 may identify a frontend module for processing a received wireless LAN signal based on a bandwidth of the received wireless LAN signal. As an example, example, based on receiving a wireless LAN signal with a bandwidth exceeding 160 MHz, the processor 120 may process the wireless LAN signal using the second frontend module. As another example, based on receiving a wireless LAN signal with a bandwidth of 160 MHz or less, the processor 120 may process the wireless LAN signal using the first frontend module.

According to an embodiment, the processor 120 may obtain one of a fifth signal in the 5 GHz band and a sixth signal in the 6 GHz band, based on at least one signal provided to the third diplexer (e.g., the diplexer 660 of FIG. 6A or FIG. 7). For example, the processor 120 may obtain one of the fifth signal in the 5 GHz band and the sixth signal in the 6 GHz band, based on at least one signal provided to the third diplexer from at least one of a fourth frontend module (e.g., the frontend module 624 of FIG. 6A or FIG. 7) or a fifth frontend module (e.g., the frontend module 626 of FIG. 6A or FIG. 7).

For example, the processor 120 may obtain a fifth signal in the 5 GHz band by using a fifth filter (e.g., the filter 662 of FIG. 6A or FIG. 7) configured to pass a signal in the 5 GHz band, included in the third diplexer. The processor 120 may obtain a sixth signal in the 6 GHz band by using a sixth filter (e.g., the filter 661 of FIG. 6A or FIG. 7) configured to pass the signal on the 6 GHz band, included in the third diplexer.

For example, the processor 120 may provide at least one signal from at least one of the fourth frontend module and the fifth frontend module to the third diplexer through another switch (e.g., the switch 632 of FIG. 6A). A function of the other switch may correspond to a function of a switch connected to the first diplexer.

According to an embodiment, the processor 120 may obtain one of a seventh signal in the 2.4 GHz band and an eighth signal in the band of 5 GHz or more, based on at least one signal provided to the fourth diplexer. For example, the processor 120 may obtain one of the seventh signal in the 2.4 GHz band and the eighth signal in the band of 5 GHz or more, through the fourth diplexer, based on at least one signal provided to the fourth diplexer from at least one of the third diplexer or the sixth frontend module (e.g., the frontend module 622 of FIG. 6A or FIG. 7).

According to an embodiment, at least one signal may be provided to the fourth diplexer from at least one of the third diplexer or the sixth frontend module. For example, the processor 120 may provide (or transmit) a signal in the 2.4 GHz band to the fourth diplexer, by using the sixth frontend module. The signal in the 2.4 GHz band may be provided to the fourth diplexer. For example, a signal in the band of 5 GHz or more may be provided from the third diplexer to the fourth diplexer. The signal in the band of 5 GHz or more transmitted from the third diplexer and the signal in the 2.4 GHz band transmitted from the sixth frontend module may be provided to the fourth diplexer.

For example, the processor 120 may obtain a seventh signal in the 2.4 GHz band using a seventh filter (e.g., the filter 672 of FIG. 6A or FIG. 7), configured to pass a signal in the 2.4 GHz band, included in the fourth diplexer. The processor 120 may obtain an eighth signal in the band of 5 GHz or more using an eighth filter (e.g., the filter 671 of FIG. 6A or FIG. 7), configured to pass a signal in the band of 5 GHz or more, included in the fourth diplexer.

According to an embodiment, the fourth diplexer may be connected to another antenna (e.g., the antenna 422). A function of the other antenna may correspond to a function of an antenna connected to the second diplexer.

For example, a signal obtained through the fourth diplexer may be transmitted through another antenna. The processor 120 may transmit one of the seventh signal in the 2.4 GHz band and the eighth signal in the band of 5 GHz or more, which are obtained through the fourth diplexer, through the other antenna. For example, a signal received through the other antenna may be transmitted to the fourth diplexer.

According to an embodiment, while communicating with a first external electronic device through a first channel using at least one of the first frontend module to the third frontend module, the processor 120 may communicate with a second external electronic device through a second channel using at least one of the fourth frontend module to the sixth frontend module.

For example, a signal received from the first external electronic device may be provided to the second diplexer through an antenna. The signal received from the first external electronic device may be provided from the second diplexer to at least one of the first frontend module to the third frontend module through the first diplexer.

For example, a signal received through a first channel (or a first link) from the second external electronic device may be provided to the fourth diplexer through another antenna. The signal received through a second channel (or a second link) from the second external electronic device may be provided from the fourth diplexer to at least one of the fourth frontend module to the sixth frontend module through the first diplexer.

According to an embodiment, when the RSDB operation and/or the multi-link operation is performed, two or more channels (or two or more links) may be used. When two or more channels (or two or more links) are used, interference between each of channels (or links) may occur. Hereinafter, an example of an operation of the electronic device 101 (or the processor 120 of the electronic device 101) for avoiding interference between each of channels (or links) may be described.

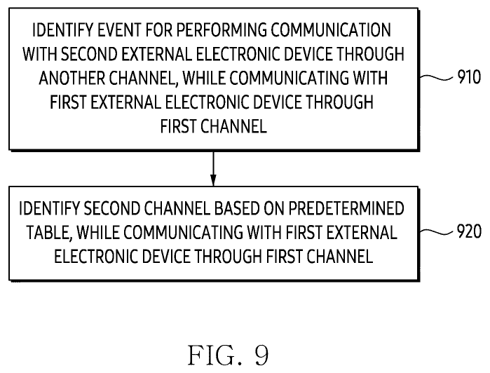

FIG. 9 is a flowchart illustrating an operation of an electronic device according to an embodiment.

Referring to FIG. 9, an operation 910 and an operation 920 of FIG. 9 may be performed by the electronic device 101 illustrated in FIG. 6A or FIG. 7.

In operation 910, while communicating with a first external electronic device through a first channel (or a first link), a processor 120 may identify an event for performing communication with a second external electronic device through another channel (or another link) distinct from the first channel.

According to an embodiment, the processor 120 may communicate with a first external electronic device through a first channel (or a first link), which is one of a plurality of channels set within the 2.4 GHz band, the 5 GHz band, and the 6 GHz band, by using a first core (e.g., the third core 603 of FIG. 6A or FIG. 7). While communicating with the first external electronic device, the processor 120 may identify an event for communicating with a second external electronic device through another channel, which is one of a plurality of channels set within the 2.4 GHz band, the 5 GHz band, and the 6 GHz band.

In operation 920, while communicating with the first external electronic device through the first channel, the processor 120 may identify a second channel for communicating with the second external electronic device based on a predetermined table. For example, the electronic device 101 may further include memory. The processor 120 may identify the second channel based on the predetermined table stored in the memory. According to an embodiment, the processor 120 may receive information on the predetermined table from a server. The processor 120 may update information on the predetermined table, based on the received information.

According to an embodiment, the processor 120 may identify the second channel set to be spaced apart from the first channel by a frequency magnitude exceeding a predefined frequency magnitude, based on the information on the predetermined table. For example, the first channel set to communicate with the first external electronic device and the second channel set to communicate with the second external electronic device may be set to be spaced apart from each other by a predefined frequency magnitude or more.

For example, the first channel may be set as one of a plurality of channels within the 5 GHz band. Based on the information on the predetermined table, the processor 120 may identify a second channel, spaced apart from the first channel by a predefined frequency magnitude or more and set as one of a plurality of channels within the 6 GHz band.

For example, the second channel may be set as one of a plurality of channels within the 6 GHz band. Based on the information on the predetermined table, the processor 120 may identify a second channel, spaced apart from the first channel by a predefined frequency magnitude or more and set as one of a plurality of channels within the 5 GHz band.

For example, the first channel may be set as one of channels in a predefined frequency band among a plurality of channels within the 5 GHz band. The processor 120 may identify one of a plurality of channels in the 6 GHz band, spaced apart from channels in the predefined frequency band among a plurality of channels in the 5 GHz band by a predefined frequency magnitude or more, as the second channel. For example, channels in a predefined frequency band among a plurality of channels in the 5 GHz band may include channel 173 or channel 177. As an example, a center frequency of channel 177 in 5 GHz may be 5.885 GHz, and a bandwidth may be 20 MHz. A center frequency of channel 173 in 5 GHz may be 5.865 GHz and a bandwidth may be 20 MHz. A center frequency of channel 1 in 6 GHz may be 5.955 GHz and a bandwidth may be 20 MHz. A center frequency of channel 5 in 6 GHz may be 5.975 GHz and a bandwidth may be 20 MHz. A center frequency of channel 9 in 6 GHz may be 5.995 GHz and a bandwidth may be 20 MHz.

For example, the first channel may be set as one of channels of a predefined frequency band among a plurality of channels in the 6 GHz band. The processor 120 may identify one of a plurality of channels in the 5 GHz band, spaced apart from channels in the predefined frequency band among a plurality of channels in the 6 GHz band by a predefined frequency magnitude or more, as the second channel. For example, channels in a predefined frequency band among a plurality of channels in the 6 GHz band may include channel 2 or channel 1. The processor 120 may identify a second channel among channels excluding channel 165, channel 169, channel 173, and channel 177, from among a plurality of channels in the 5 GHz band.

For example, based on that the first channel is set to one of channels with a first center frequency or higher among a plurality of channels in the 5 GHz band, the processor 120 may set the second channel as one of channels with a second center frequency or higher among a plurality of channels in the 6 GHz band.

According to an embodiment, the processor 120 may individually perform communication between the electronic device 101 and the first external electronic device through the first channel and communication between the electronic device 101 and the second external electronic device through the second channel. The communication between the electronic device 101 and the first external electronic device through the first channel may be individually performed from the communication between the electronic device 101 and the second external electronic device through the second channel.

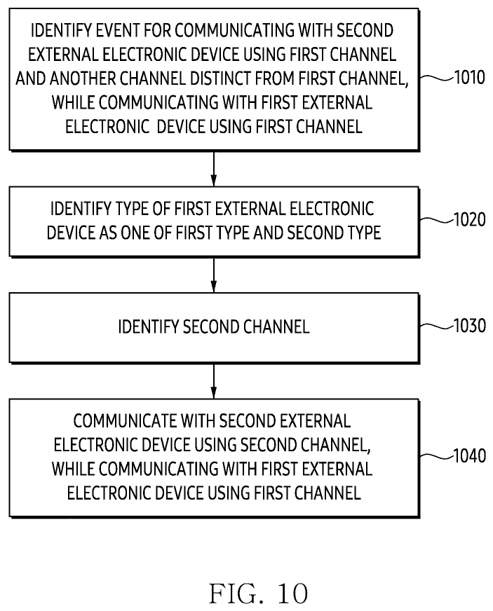

FIG. 10 is a flowchart illustrating an operation of an electronic device according to an embodiment.

Referring to FIG. 10, operations 1010 to 1040 of FIG. 9 may be performed by the electronic device 101 illustrated in FIG. 6A or FIG. 7.

In operation 1010, while communicating with a first external electronic device using a first channel, a processor 120 may identify an event for communicating with a second external electronic device using the first channel and another channel distinct from the first channel.

For example, the processor 120 may identify an event for performing an RSDB operation or a multi-link operation. As an example, the processor 120 may identify an event for establishing a connection with the second external electronic device based on the RSDB operation. As another example, the processor 120 may identify an event for establishing a connection with the second external electronic device based on the multi-link operation.

In operation 1020, the processor 120 may identify a type of the first external electronic device as one of a first type and a second type. For example, the processor 120 may identify the type of the first external electronic device as one of the first type and the second type, based on the identified event.

According to an embodiment, the processor 120 may identify the type of the first external electronic device as the first type, based on that the first external electronic device performs a function of an AP. The processor 120 may identify the type of the first external electronic device as the second type, based on that the first external electronic device does not perform the function of the AP.

According to an embodiment, the processor 120 may identify the type of the first external electronic device as the second type, based on that a connection between the first external electronic device and the electronic device 101 is a P2P connection. The processor 120 may identify the type of the first external electronic device as the first type, based on that the connection between the first external electronic device and the electronic device 101 is not the P2P connection.

In operation 1030, the processor 120 may identify the second channel. For example, the processor 120 may identify the second channel based on channel information identified based on the type of the first external electronic device.

According to an embodiment, the processor 120 may identify channel information based on the type of the first external electronic device. For example, the channel information may include information on at least one available channel. The processor 120 may identify information on at least one available channel, based on the type of the first external electronic device. The processor 120 may identify the second channel, based on the information on the at least one available channel. The processor 120 may identify the identified second channel as another channel, distinct from the first channel, for communicating with the second external electronic device.

For example, based on the channel information, the processor 120 may identify the second channel spaced apart from the first channel by a predefined frequency magnitude or more. Based on the channel information, the processor 120 may identify at least one channel, spaced apart from the first channel by a predefined frequency magnitude or more. The processor 120 may identify the second channel from among the at least one channel.

For example, the first channel may be set as one of a plurality of channels configured in a first band (e.g., 5 GHz band). The second channel may be set as one of a plurality of channels configured in a second band (e.g., a 6 GHz band) distinct from the first band.

In operation 1040, while communicating with the first external electronic device using the first channel, the processor 120 may communicate with the second external electronic device using the second channel. For example, the processor 120 may generate (or process) a signal for communicating with the first external electronic device using a first core. The processor 120 may generate (or process) a signal for communicating with the second external electronic device using a second core.

According to an embodiment, while communicating with the first external electronic device using the first channel (or the first link), the processor 120 may identify an event for communicating with the first external electronic device using an additional channel. The processor 120 may identify a third channel (or a third link) based on the first channel (or the first link). The processor 120 may identify the third channel as the additional channel.

For example, the processor 120 may identify the third channel spaced apart from the first channel by a predefined frequency magnitude or more. As an example, the processor 120 may set the third channel as one of channels with a second center frequency or higher among a plurality of channels in the 6 GHz band, based on that the first channel is set as one of channels with a first center frequency or higher among a plurality of channels in the 5 GHz band.

After identifying the third channel (or third link), the processor 120 may set a channel for communicating with the first external electronic device as the first channel (or the first link) and the third channel (or the third link). The processor 120 may communicate with a first external electronic device (e.g., AP) by simultaneously using the first channel (or the first link) and the third channel (or the third link).

According to an embodiment, the processor 120 may communicate with the first external electronic device and the second external electronic device by using a frontend circuit and at least one antenna. For example, the frontend circuit may include a first frontend module, a second frontend module, a third frontend module, a fourth frontend module, a fifth frontend module, a sixth frontend module, a first diplexer, a second diplexer, a third diplexer, and a fourth diplexer.

For example, the first diplexer may include a first filter that passes a signal in the 5 GHz band. The first diplexer may include a second filter that passes a signal in the 6 GHz band. The first diplexer may be connected to the first frontend module and the second frontend module, respectively.

For example, the second diplexer may include a third filter that passes a signal in the 2.4 GHz band. The second diplexer may include a fourth filter that passes a signal in the band of 5 GHz or more. The second diplexer may be connected to the third frontend module and the first diplexer, respectively. The second diplexer may be connected to a first antenna among at least one antenna for emitting a signal received from the third frontend module and the first diplexer. The signal received through the first antenna may be provided to at least one of the third frontend module and the first diplexer through the second diplexer.

For example, the third diplexer may include a fifth filter that passes a signal in the 5 GHz band. The third diplexer may include a sixth filter that passes a signal in the 6 GHz band. The third diplexer may be connected to the fourth frontend module and the fifth frontend module, respectively.

For example, the fourth diplexer may include a seventh filter that passes a signal in the 2.4 GHz band. The fourth diplexer may include an eighth filter that passes a signal in the band of 5 GHz or more. The fourth diplexer may be connected to the sixth frontend module and the third diplexer, respectively. The fourth diplexer may be connected to a second antenna among at least one antenna for emitting a signal received from the sixth frontend module and the third diplexer. The signal received through the second antenna may be provided to at least one of the sixth frontend module and the third diplexer through the fourth diplexer.

According to an embodiment, an electronic device (e.g., the electronic device 101 of FIG. 6A) may comprise a first frontend module (or first frontend circuitry) (e.g., the first frontend module 623 of FIG. 6A), a second frontend module (or second frontend circuitry) (e.g., the first frontend module 625 of FIG. 6A), a third frontend module (or third frontend circuitry) (e.g., the first frontend module 621 of FIG. 6A), a first diplexer (e.g., the first diplexer 640 of FIG. 6A) connected with the first frontend module and the second frontend module respectively, comprising a first filter (e.g., the first filter 642 of FIG. 6A) configured to pass a signal in a 5 GHz band and a second filter (e.g., the second filter 641 of FIG. 6A) configured to pass a signal in a 6 GHz band, a second diplexer (e.g., the second diplexer 650 of FIG. 6A) connected with the third frontend module and the first diplexer respectively, comprising a third filter (e.g., the third filter 652 of FIG. 6A) configured to pass a signal in a 2.4 GHz band and a fourth filter (e.g., the fourth filter 651 of FIG. 6A) configured to pass a signal in a band over 5 GHz, and at least one processor. The at least one processor (e.g., the processor 120) may be configured to obtain (or identify) one signal among a first signal in the 5 GHz band and a second signal in the 6 GHz band, based on at least one signal provided to the first diplexer from at least one of the first frontend module or the second frontend module through the first diplexer, and identify one signal among a third signal in the 2.4 GHz band and a fourth signal in the band over 5 GHz, based on at least one signal provided to the second diplexer from at least one of the first diplexer or the third frontend module through the second diplexer.

According to an embodiment, the electronic device may comprise an antenna connected to the second diplexer. The signal obtained through the second diplexer may be transmitted through the antenna.

According to an embodiment, the electronic device may comprise a switch. The at least one processor may be configured to provide at least one signal to the first diplexer through the switch from at least one of the first frontend module and the second frontend module.

According to an embodiment, the at least one processor may be configured to change a state of the switch for changing at least one signal provided from at least one of the first frontend module and the second frontend module.

According to an embodiment, the electronic device may comprise a fourth frontend module (or fourth frontend circuitry), a fifth frontend module (or fifth frontend circuitry), a sixth frontend module (or sixth frontend circuitry), a third diplexer connected to the fourth frontend module and the fifth frontend module respectively, comprising a fifth filter configured to pass a signal in the 5 GHz band and a sixth filter configured to pass a signal in the 6 GHz band, a fourth diplexer connected to the sixth frontend module and the third diplexer module respectively, comprising a seventh filter configured to pass a signal in the 2.4 GHz band and a eighth filter configured to pass a signal in the band over 5 GHz, and another antenna connected to the fourth diplexer.

According to an embodiment, the at least one processor may be configured to, while communicating with a first external electronic device, using at least one of the first frontend module to the third frontend module, through a first channel, establish a connection (or connect) with a second external electronic device, using at least one of the fourth frontend module to the sixth frontend module, through a second channel.

According to an embodiment, the at least one processor may be configured to identify (or set) the second channel based on a predetermined table, while communicating with the first external electronic device through the first channel.

According to an embodiment, the electronic device may comprise memory. The at least one processor may be configured to store, in the memory, the predetermined table. The at least one processor may be configured to receive, from a server, information on the predetermined table. The at least one processor may be configured to store, based on the received information, the predetermined table.

According to an embodiment, the first channel set to communicate with the first external electronic device and the second channel set to communicated with the second external electronic device may be set to be spaced apart from each other by a frequency magnitude exceeding a predefined frequency magnitude.

According to an embodiment, the at least one processor may be configured to perform a communication between the electronic device and the first external electronic device through the first channel and a communication between the electronic device and the second external electronic device through the second channel, individually.

According to an embodiment, the first channel may be set to one of a plurality of channels set within the 2.4 GHz band, the 5 GHz band, and the 6 GHz band. The second channel may be set to one of a plurality of channels set within the 2.4 GHz band, the 5 GHz band, and the 6 GHz band.

According to an embodiment, the at least one signal provided to the second diplexer may comprise a wireless local area network (WLAN) signal in the 2.4 GHz band or a bluetooth signal in the 2.4 GHz band, which are transmitted from the third frontend module. The at least one processor may be configured to process, using the third frontend module, the WLAN signal in the 2.4 GHz band or the bluetooth signal in the 2.4 GHz band.

According to an embodiment, the at least one signal provided to the first diplexer from at least one of the first frontend module and the second frontend module may comprise a wireless local area network (WLAN) signal in the 5 GHz band or the 6 GHz band. The at least one processor may be configured to process the WLAN signal in the 5 GHz band or the 6 GHz band, using the first frontend module or the second frontend module.

According to an embodiment, the at least one processor may be configured to process the WLAN signal in the 5 GHz band, using the first frontend module. The at least one processor may be configured to process the WLAN signal in the 6 GHz band, using the second frontend module.

According to an embodiment, the at least one processor may be configured to process a WLAN signal with a bandwidth less than a first reference bandwidth, using the first frontend module. The at least one processor may be configured to process a WLAN signal with a bandwidth less than a second reference bandwidth, using the second frontend module. The first reference bandwidth may be set to be smaller than the second reference bandwidth.

According to an embodiment, an electronic device may comprise at least one antenna, a frontend circuit electrically connected to the at least one antenna, and at least one processor operably coupled to the frontend circuit. The at least one processor may be configured to identify, while communicating with a first external electronic device using a first channel, an event for performing communication with a second external electronic device, using the first channel and another channel distinct from the first channel. The at least one processor may be configured to identify a type of the first external electronic device as one of a first type and a second type, based on the event. The at least one processor may be configured to identify a second channel based on channel information identified based on the type of the first external electronic device. The at least one processor may be configured to identify the identified second channel as the other channel. The at least one processor may be configured to, while communicating with the first external electronic device using the first channel, communicate with the second external electronic device using the second channel.

According to an embodiment, the at least one processor may be configured to identify the second channel, which is spaced apart from the first channel by a frequency magnitude exceeding a predefined frequency magnitude, based on the channel information.

According to an embodiment, the first channel may be set as one of a plurality of channels configured in a first band. The second channel may be set as one of a plurality of channels configured in a second band distinct from the first band.

According to an embodiment, the at least one processor may be configured to identify an event for allocating an additional channel while communicating with the first external electronic device using the first channel. The at least one processor may be configured to identify a third channel, based on channel information identified based on a type of the first external electronic device. The at least one processor may be configured to identify the identified third channel as the additional channel. The at least one processor may be configured to communicate with the first external electronic device by simultaneously using the first channel and the third channel.

According to an embodiment, the frontend circuit may include a first frontend module, a second frontend module, a third frontend module, a fourth frontend module, a fifth frontend module, a sixth frontend module, a first diplexer connected with the first frontend module and the second frontend module respectively, comprising a first filter configured to pass a signal in a 5 GHz band and a second filter configured to pass a signal in a 6 GHz band, a second diplexer connected with the third frontend module and the first diplexer respectively, comprising a third filter configured to pass a signal in a 2.4 GHz band and a fourth filter configured to pass a signal in a band over 5 GHz, a third diplexer connected to the fourth frontend module and the fifth frontend module respectively, comprising a fifth filter configured to pass a signal in the 5 GHz band and a sixth filter configured to pass a signal in the 6 GHz band, and a fourth diplexer connected to the sixth frontend module and the third diplexer module respectively, comprising a seventh filter configured to pass a signal in the 2.4 GHz band and a eighth filter configured to pass a signal in the band over 5 GHz.

According to an embodiment, each of the first frontend module to the sixth frontend module may be configured as at least one chip (or a chip). For example, the electronic device may comprise a chip (or at least one chip) for the first frontend module. For example, the electronic device may comprise a chip (or at least one chip) for the second frontend module. For example, the electronic device may comprise a chip (or at least one chip) for the third frontend module. For example, the electronic device may comprise a chip (or at least one chip) for the fourth frontend module. For example, the electronic device may comprise a chip (or at least one chip) for the fifth frontend module. For example, the electronic device may comprise a chip (or at least one chip) for the sixth frontend module. According to an embodiment, at least one of the first to sixth frontend modules may be configured as a single chip.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
first frontend circuitry;
second frontend circuitry;
third frontend circuitry;
a first diplexer connected to the first frontend circuitry and the second frontend circuitry, the first diplexer comprising a first filter configured to pass a signal in a 5 GHz band and a second filter configured to pass a signal in a 6 GHz band;
a second diplexer connected to the third frontend circuitry and the first diplexer, the second diplexer comprising a third filter configured to pass a signal in a 2.4 GHz band and a fourth filter configured to pass a signal in a band over 5 GHz; and
at least one processor, wherein the at least one processor is configured to:
obtain a signal through the first diplexer from among a first signal in the 5 GHz band and a second signal in the 6 GHz band, based on at least one signal provided to the first diplexer from at least one of the first frontend circuitry or the second frontend circuitry, and
obtain a signal through the second diplexer from among a third signal in the 2.4 GHz band and a fourth signal in the band over 5 GHz, based on at least one signal provided to the second diplexer from at least one of the first diplexer or the third frontend circuitry.

2. The electronic device of claim 1, further comprising an antenna connected to the second diplexer; and
wherein the signal obtained through the second diplexer is transmitted through the antenna.

3. The electronic device of claim 1, further comprising a switch,
wherein the at least one processor is further configured to provide at least one signal to the first diplexer through the switch from at least one of the first frontend circuitry and the second frontend circuitry.

4. The electronic device of claim 3, wherein the at least one processor is further configured to change a state of the switch to modify at least one signal provided from at least one of the first frontend circuitry and the second frontend circuitry.

5. The electronic device of claim 1, wherein the electronic device further comprising:
fourth frontend circuitry;
fifth frontend circuitry;
sixth frontend circuitry;
a third diplexer connected to the fourth frontend circuitry and the fifth frontend circuitry, the third diplexer comprising a fifth filter configured to pass a signal in the 5 GHz band and a sixth filter configured to pass a signal in the 6 GHz band;
a fourth diplexer connected to the sixth frontend circuitry and the third diplexer circuitry, the fourth diplexer comprising a seventh filter configured to pass a signal in the 2.4 GHz band and an eighth filter configured to pass a signal in the band over 5 GHz; and
another antenna connected to the fourth diplexer.

6. The electronic device of claim 5, wherein the at least one processor is further configured to:
while communicating with a first external electronic device, using at least one of the first frontend circuitry, the second frontend circuitry, or the third frontend circuitry, through a first channel, establish a connection with a second external electronic device, using at least one of the fourth frontend circuitry, the fifth frontend circuitry, or the sixth frontend circuitry, through a second channel.

7. The electronic device of claim 6, wherein the at least one processor is configured to determine the second channel based on a predetermined table, while communicating with the first external electronic device through the first channel.

8. The electronic device of claim 7, further comprising a memory, wherein the at least one processor is further configured to:
store, in the memory, the predetermined table,
receive, from a server, information on the predetermined table, and
update, based on the received information, the predetermined table.

9. The electronic device of claim 7, wherein the first channel set to communicate with the first external electronic device and the second channel set to communicate with the second external electronic device are configured to be spaced apart from each other by a frequency magnitude exceeding a predefined frequency magnitude.

10. The electronic device of claim 6, wherein the at least one processor is configured to:
perform a communication between the electronic device and the first external electronic device through the first channel and perform a communication between the electronic device and the second external electronic device through the second channel, individually.

11. The electronic device of claim 6, wherein the first channel is set to one of a plurality of channels within the 2.4 GHz band, the 5 GHz band, or the 6 GHz band, and
wherein the second channel is set to one of a plurality of channels within the 2.4 GHz band, the 5 GHz band, or the 6 GHz band.

12. The electronic device of claim 1, wherein the at least one signal provided to the second diplexer comprises a wireless local area network (WLAN) signal in the 2.4 GHz band or a bluetooth signal in the 2.4 GHz band, which are transmitted from the third frontend circuitry, and
wherein the at least one processor is configured to process, using the third frontend circuitry, the WLAN signal in the 2.4 GHz band or the bluetooth signal in the 2.4 GHz band.

13. The electronic device of claim 1, wherein the at least one signal provided to the first diplexer from at least one of the first frontend circuitry and the second frontend circuitry, comprises a wireless local area network (WLAN) signal in the 5 GHz band or the 6 GHz band; and
wherein the at least one processor is configured to process the WLAN signal in the 5 GHz band or the 6 GHz band, using the first frontend circuitry or the second frontend circuitry.

14. The electronic device of claim 13, wherein the at least one processor is configured to:
process the WLAN signal in the 5 GHz band, using the first frontend circuitry; and
process the WLAN signal in the 6 GHz band, using the second frontend circuitry.

15. The electronic device of claim 13, wherein the at least one processor is configured to:
process a WLAN signal with a bandwidth less than a first reference bandwidth, using the first frontend circuitry, and
process a WLAN signal with a bandwidth less than a second reference bandwidth, using the second frontend circuitry,
wherein the first reference bandwidth is smaller than the second reference bandwidth.

16. An electronic device comprising:
at least one antenna;
frontend circuitry electrically connected to the at least one antenna; and
at least one processor, wherein the at least one processor is configured to:
identify, while communicating with a first external electronic device using a first channel, an event for performing communication with a second external electronic device, using the first channel and another channel distinct from the first channel,
identify a type of the first external electronic device as one of a first type and a second type, based on the event,
identify a second channel based on channel information identified based on the type of the first external electronic device, and
identify the identified second channel as the other channel,
while communicating with the first external electronic device using the first channel, communicate with the second external electronic device using the second channel.

17. The electronic device of claim 16, wherein the at least one processor is configured to identify the second channel, which is spaced apart from the first channel by a frequency magnitude exceeding a predefined frequency magnitude, based on the channel information.

18. The electronic device of claim 16, wherein the first channel is set as one of a plurality of channels configured in a first band, and
wherein the second channel is set as one of a plurality of channels configured in a second band distinct from the first band.

19. The electronic device of claim 16, wherein the at least one processor is configured to:
identify an event for allocating an additional channel while communicating with the first external electronic device using the first channel,
identify a third channel, based on channel information identified based on a type of the first external electronic device,
identify the identified third channel as the additional channel, and
communicate with the first external electronic device by simultaneously using the first channel and the third channel.

20. The electronic device of claim 18, wherein the frontend circuitry includes:
first frontend circuitry,
second frontend circuitry,
third frontend circuitry,
fourth frontend circuitry,
fifth frontend circuitry,
sixth frontend circuitry,
a first diplexer connected with the first frontend circuitry and the second frontend circuitry respectively, comprising a first filter configured to pass a signal in a 5 GHz band and a second filter configured to pass a signal in a 6 GHz band,
a second diplexer connected with the third frontend circuitry and the first diplexer respectively, comprising a third filter configured to pass a signal in a 2.4 GHz band and a fourth filter configured to pass a signal in a band over 5 GHz,
a third diplexer connected to the fourth frontend circuitry and the fifth frontend circuitry respectively, comprising a fifth filter configured to pass a signal in the 5 GHz band and a sixth filter configured to pass a signal in the 6 GHz band, and
a fourth diplexer connected to the sixth frontend circuitry and the third diplexer circuitry respectively, comprising a seventh filter configured to pass a signal in the 2.4 GHz band and an eighth filter configured to pass a signal in the band over 5 GHz.
